(19) United States
(12) Patent Application Publication
(10) Pub. No.: US 2014/0278928 A1
(43) Pub. Date: Sep. 18, 2014

(54) PLATFORM AND METHOD TO CONNECT ADVERTISERS WITH COMMUNITY GROUPS

(71) Applicant: Gary John Smith, Hornsby (AU)

(72) Inventor: Gary John Smith, Hornsby (AU)

(21) Appl. No.: 13/830,389

(22) Filed: Mar. 14, 2013

(51) Int. Cl. G06Q 30/02

(52) U.S. Cl. CPC G06Q 30/0277
USPC 705/14.45; 705/14.73; 705/14.7

(57) ABSTRACT

An intermediary platform and method for connecting community groups with sponsors. Club information and membership information is obtained for a club. That information is analyzed to identify demographic and geographic characteristics of the membership. Those characteristics are matched against a pool of sponsors to identify a subset of possible sponsors. A sponsor website is created that is unique to the particular club including paid advertising from advertisers from the subset that agree to advertise on the club's sponsor site. Revenue from the advertising is shared with the club. Other embodiments are also described and claimed.

### FIELD

Embodiments of the invention relate to funding local organizations. More specifically, embodiments of the invention provide a method and platform that generate advertising revenue in support of local organizations.

### BACKGROUND

There is an existing and growing funding gap between funding available for and the needs of local organizations such that supports clubs, schools, etc. Traditional funding for such grassroots organizations has been through bake sales, magazine sales, chocolate sales, and the like. Such ventures require significant time and effort by club members and tend to yield relatively low returns. While some organizations successfully approach local businesses for donations, this is generally on an ad hoc basis and often does not yield the desired result either in terms of revenue from the club side or exposure from the local business side. Moreover, typically community based groups have neither the access nor the ability to approach large corporations for sponsorship. A system to address the funding challenges of community organizations is desirable.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a block diagram of a system of one embodiment of the invention.

FIG. 2 is a flow diagram of operation of an intermediary platform according to one embodiment of the invention.

FIG. 3 is a schematic diagram depicting three web pages that may exist in accordance with one embodiment of the invention.

### DETAILED DESCRIPTION

In an effort to solve the problems of funding local organizations, a platform that acts as an intermediary between these local organizations and possible advertisers/sponsors (these terms are used interchangeably herein). Clubs register with the platform if they wish to take advantage of the possible revenue stream it provides. As used herein, “club” refers to community groups such as sports clubs, schools, local charities, and similar grassroots community based groups. Generally, there is no cost to the club to register. This creates a “nothing to lose” environment for the club. Advertisers also register with the platform, their registration may be self prompted e.g. by world of mouth or solicited by e.g. sales personnel acting for the platform operator. The registered advertisers collective for the advertiser/sponsor pool. This pool can continually expand as additional advertiser can sign up at any time. Generally, there is no cost to the advertiser sign up, as explained in more detail below advertisers are charged for advertising on websites associated with the clubs. Revenue from that advertising is shared with the club providing the club with a reliable revenue stream with no additional work from club members.

FIG. 1 is a block diagram of a system of one embodiment of the invention. The sponsorship intermediary platform 100 is coupled over a wide area network such as web 104 to a plurality of club nodes 106-1, 106-2, 106-m (generically club node 106). Each club node 106 corresponds to a particular web presence of a club using platform 100 as a revenue source. Each club by definition has a number of members that may connect to web 104 via member nodes 110-1, 110-2, 110-p (generically number node 110). A member node 110 is any access point by which club members access the web. In one embodiment, Club node 106 can be thought of as the provider of (host of) the club website or the node through which the club website is administered. Members via the member nodes 110 navigate web 104 to the home site of their clubs. While “m” (the number of clubs using the platform 102) may be arbitrarily large, the number “p” corresponds to the number of club members and will be many times larger.

Also residing the location on web 104 are a plurality of advertiser nodes 108-1, 108-2, 108-n (generically advertiser node 108). Advertiser nodes correspond to advertisers that use platform 102 to reach out to club members. The total number of advertisers “n” in the advertiser pool may be arbitrarily large and is expected to exceed the number of clubs “m” by at least an order of magnitude. Suitable possible advertisers include substantially any local business, local branches of large corporations, local franchises and even large national or multinational corporations.

Platform 100 includes a processor 102 that exposes a club interface 116 to web 104. Club interface 106 provides a portal through which clubs can apply to participate in the platforms revenue sharing and upload club data 134 and membership data 136. This data may be persistently stored in a database 112 in for example, club data partition and membership data partition. Club data 134 generally refers to information such as total membership, possibly aggregate demographic or geographic information, club purpose, club node URL, club masthead, banking information for revenue sharing and similar data. Club membership data 136 generally refers to information about specific club members including contact information such as email address or physical address as well as demographic or geographic information related to individual club members.

Executing on processor 102 is a customer relation management (CRM) module 120 which largely controls club sign up and sponsor signup as discussed in more detail below. Processor 102 also exposes an advertiser interface 118 to web 104 to permit advertisers to apply to participate in the platform services. At sign up, Advertisers provide advertiser data 138 that may be persisted as a partition in database 112. Advertiser data may include a specification of a target geographic and/or demographic as well as an image-based ad to be used with appropriate clubs and separately branch or local contact information. By way of example, a national bank may be seeking a demographic e.g. ages 25-45 without a geographic constraint. But, where a club having this demographic is identified, local geographic data may be overlaid on the base ad as discussed in greater detail below.

The advertiser data 138 may also include one or more rules that may be automatically applied to identify the willingness of a particular advertiser to sponsor a particular club. Using the national bank example, it may have as part of its advertising data rules that indicate 1) It will sponsor any club with a demographic 25-45 at a first level and 2) it will sponsor any club with this demographic and more than 5000 members at a second higher level. While this rule set is simple for illustration, arbitrarily complex rule set may be used. Advertising data may also include information on the type of business, which may be used to filter the advertiser from advertising to different clubs. For example, an alcohol producer would not appropriately sponsor a youth sports league notwithstanding that the producer wanted to reach the demographic of the parent (members) of that organization.

Once a CRM 120 has persisted advertising data 138 for the pool of advertisers, club data 134 for a participating club and membership data 136 for that participating club CRM 120 uses analytic module 124 to identify a subset of advertisers from the advertising pool having geographic and demographic characteristics matching those of the participating club. As used herein “subset” means any positive integer number of items from the larger group. As mentioned above, some advertisers may have rules that permit automatic acceptance based on application of specified rules. For those advertisers an electronic notification and invoice may be generated immediately through accounting module 122.

Other identified advertisers in the subset may be contacted at corresponding advertiser node 108 and made aware of the advertising opportunity with the participating club. Once enough advertisers in the subset accept (automatically or volitionally) the advertising opportunity CRM 120 uses website management (WSM) module 130 to create a website or sponsor site 142 corresponding to the participating club. These sponsor sites 142-1, 142-2, 142-m (generically sponsor sites 142) may be stored in a database 114. The collection 132 of sponsor sites 1142 include individual the sponsor sites 142-1, 142-2 through 142-m with one website corresponding uniquely to each participating club. Thus, there are m distinct websites for the m participating clubs. This one to one correspondence discounts the possibility of aggregation of clubs having a membership too small to meet a threshold, which is discussed in more detail below.

Website management module 130 exposes the sponsor sites 142 to web 104 once a threshold number of acceptable advertisers have paid for their advertisements. Payment processing may be handled by accounting module 122 which may provide for electronic receipt of payment from advertisers and subsequent electronic payment to accounts specified by participating clubs. In one embodiment, the participating club has no cost for participation and receives 20-50% of the revenue derived from advertising on their unique sponsor site 142.

Once the sponsor site is determined to have met the minimum threshold number of advertisers (that is it is ready to go live), CRM module 120 uses token generation module 126 to create and distribute tokens to the members of the participating club. In one embodiment, tokens may be distributed as electronic tokens through for example, a smartphone app. In other embodiments, the tokens can be distributed as physical membership cards identifying the particular member as a member of the participating club. The token permits the member to access club specific offers from the sponsors either as point of sale promotions or electronically.

Once a sponsor site is live, analytic module 124 tracks the traffic through the sponsor site 142 including such data as view rate, click through rate, etc. to evaluate the efficacy of advertisements on individual sites. In some embodiments, a report of the analytics results is provided to the advertiser. In cases where a particular advertiser participates on multiple club sites the analytics between all sites can be correlated and aggregated and reports of the efficacy of the advertisement provided to the advertiser. In this manner, an advertiser may be able to provide two different base advertisements and evaluate which advertisement is more effective in reaching the target audience. For example, by placing the different ads on two different sponsor sites having similar demographics, the analytics will reveal which ad receives the more positive reception from that demographic.

In some embodiments, platform 100 assumes responsibility for club correspondence such as for example, club newsletters. Club nodes 106 upload newsletter content through club interface 116 CRM uses news module 128 to populate newsletter templates with the uploaded information. By providing an appropriate template to club nodes 106, platform 100 ensures the appropriate formatting of the uploaded information. Information may include news, calendars and events and all club generated data expected to appear in the newsletter. Additionally, CRM may populate the newsletter with special offers applicable to the particular club from its various sponsors. While the newsletter may be distributed electronically, it is also envisioned that physical newsletters may be sent. In the case of electronic newsletters, active hyperlinks to sponsors special offers may be embedded.

While this figure shows a single processor 102 executing the numerous modules, it is expected that the system may use a multiprocessor environment, a distributed procession environment, or even a cloud-processing environment. Similarly, while two distinct databases, one for holding the collection of the sponsor sites 132 and another with partitions of club, advertiser, and member data it can be integrated as a single database or expanded to even more databases. Moreover, all aspects of platform 100 need not be instantiated at a same physical location. Rather, different constituents may communicate across the web 104 with each other or be connected by another local or wide area network.

FIG. 2 is a flow diagram of operation of an intermediary platform according to one embodiment of the invention. At block 202, the platform receives a sign up request for a newly participating club. At block 204, club data and membership data are ported into the platform from the club administrator. Based on that data, a decision is made at decision block 206 whether the club membership exceeds the threshold required to participate on the platform. It has been found that clubs with memberships less than 1000 generally do not draw sufficient interest from advertisers to provide meaningful revenue to the clubs. Therefore, in one embodiment, the threshold is set at a minimum membership of 1000. However, embodiments of the invention may choose a threshold higher or lower than 1000.

If at decision block 206 the minimum threshold membership has not been met, at decision block 208 a determination is made whether other clubs not meeting a threshold membership are available to aggregate with the requested club. If no other clubs are available for aggregation, at block 214 the requesting clubs request for participation is held pending successful subsequent aggregation to meet the minimum threshold at block 214. Implicit from this flow is that for a club to be available for aggregation, another club not having the threshold is being held at block 214.

If clubs are available for aggregation, a determination is made at decision block 210 whether the available clubs have the same demographics and geographic characteristics such that aggregation is plausible in a sponsorship context. If not, the club participation request is held at block 214. If there is sufficient commonality in demographic and geographic characteristics to justify aggregation, the membership is aggregated at block 212. The system then returns to block 206 to determine that the aggregated club has sufficient membership. It is noted that this aggregation results in the combined (aggregated) club being treated as a unit for purposes of sponsorship and subsequent payment. Distribution between the aggregated clubs may be performed on a per capita basis based on membership or evenly divided based on the number of participating clubs. Generally, revenue sharing based on membership is preferred. This aggregation feature also permits relatively small clubs to access a platform as a revenue source where it would not otherwise be possible.

Once the club or combined club is determined to have exceeded the membership threshold at block 206, the platform matches the geographic and demographic characteristics of the club with a sponsor pool based on matching geographic and/or demographic characteristics, the subset of the sponsor pool that may be suitable to advertise with the particular club is identified. In some cases, as alluded to above, a particular sponsor may indicate its willingness to participate automatically based on predefined rules such as the closeness of the match between specified geography and demographic characteristics. In other cases, the platform solicits a matching sponsor subset to participate in advertising for the particular club. For example, the solicitation may take the form of an email or other electronic message to a specified point of contact at the registered advertiser. The advertiser may then respond electronically with their assent to be included as a sponsor for the particular club.

At block 220 a determination is made if a threshold number of sponsors have been found. That is, sufficient sponsors to justify the website going live have accepted a sponsorship role and placed an advertisement with the particular club. In one embodiment, the threshold number of advertisers may be established at twenty advertisers. Other embodiments may use more or fewer advertisers as the threshold. Other embodiments may use a dollar value threshold instead of the gross number of advertisers. Still other embodiment may use a hybrid of number and dollar value to ensure a critical mass is reached. If at decision block 220 a threshold number of advertisers have not been found, additional advertisers are solicited at block 222. Once the threshold number of advertises have been found at clock 220, the platform organizes an electronic billing and collection of the advertising revenue as well as distribution of the club's share to the club. In one embodiment, the revenue is collected prior to exposure of the sponsor's ad on a sponsor site.

At block 226, the platform retrieves the base image advertisement from the database. This base image advertisement may have been provided previously by the advertiser when originally signing up for participation on the platform, or may be provided in response to the solicitation of sponsors for this particular club. The base advertisement is then populated with local contact information at block 228. A sponsor website for the particular club is generated at block 230 with the advertisement of reach participating sponsor displayed thereon. When the website generated at block 230 is ready to go live, the platform provides a link or web button to the club administrator for inclusion in the clubs website. At block 234 the platform generates and distributes tokens to the club members that provide access to special offers that may be available to the membership either through the clubs specific sponsor website or through point of sale promotions at the sponsor's physical location.

In some embodiments, the platform may also provide push marketing of special offers. In such case at block 236 a determination is made if special offers exist for sponsors of the particular club. If no special offers exist and for example, have not existed for some period of time the platform may alert the sponsor of this fact electronically such that if desired the sponsor may provide a special offer. If said such special offers exits, the system may push those special offers to members at block 240. This push may occur either as periodic electronic messages or as part of a regular newsletter.

While the foregoing describes an example of operation when a new club signs up, the particular ordering of some of operation may occur in parallel or in a different order that set forth in FIG. 2. Moreover, participation of sponsors is not limited to the initial signup of the club. A sponsor may identify a club it wishes to sponsor at any time after initial signup and is subject to payment of the advertising fee may be substantially immediately included in the sponsor website. Additionally, advertisers arriving after the sponsor website is active may provide a specification e.g. by advertising interface 118 which can be used to identify existing sponsor websites in which they may wish to advertise. Their advertisements may be immediately added thereafter and the corresponding revenue shared with the club. More over, the platform may provide the facility for an advertiser to change its target specification through the advertiser interface and be presented with participating clubs matching that demographic. In some embodiments, the platform may periodically search based on advertiser specification and alert the advertisers of clubs matching their specification the particular advertiser is not currently sponsoring. In some embodiments, any club previously rejected by the advertiser is filtered from this list.

FIG. 3 is the diagram showing three web pages that may exist in accordance with one embodiment of the invention. Web page 302 is the home page of a participating club. In this example shown as the fictitious URL www.clubhome.com As expected from a club home site it may include club news, club images, links of interest, but importantly includes the soft button 320 which links the club site 302 with the initial page 304 of a sponsor site here identified as the fictitious URL www.clubsponsor.com As page 304 is unique to the club having the home 302 it includes the club masthead, limited time special offers available to club members which may dynamically change as their availability times out and a category list 314 which lists categories of advertisers participating in the sponsorship site. For example, bankers, lawyers, restaurants etc. Each of the headings in the category list provides a link to a further web page directed to that service category. A return link to the club home page 322 is also provided on each page of the sponsor site. By activating the restaurant link a user arrives at web page 306 which has the fictitious URL www.clubsponsor.com/restaurant Advertising page 306 includes the category list 314 but also includes an advertising frame 316 in which image based ads 324-1, 324-r for sponsoring restaurants appear. An image based ad 324-1 for restaurant 1 may have an image relevant to the restaurant such as a pizza or other relevant image along with local contact information such as address, phone number and so forth as overlaid on the base advertisement. A link to the sponsor's website may also be embedded in the ad. The ordering of the ad within the ad frame may be randomly determined with each substantiation of the page, or may be dictated in a pay to play manner where higher advertising expenditures results in higher placement of the ad within the list. Additionally, the image based advertisements may be of various sizes with different sizes influencing the cost of the advertising.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the embodiments of the invention have been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
obtaining membership data for a club from a database;
parsing the membership data in a computer to identify geographic and demographic characteristics of the membership;
identifying in the computer, a set of advertisers from a pool of advertisers based on the geographic and demographic characteristics;
selecting a subset of the advertisers to sponsor the club;
generating a webpage having an image based advertisement for each selected advertiser; and
associating the webpage with a website of the club.

2. The method of claim 1 further comprising:
tracking electronic traffic on the webpage; and
generating a report for each selected advertiser rating an efficacy of the advertisement.

3. The method of claim 1 wherein generating comprise:
selecting an approved base image for an advertisement; and
supplementing the base image with local contact information based on the geographic characteristics.

4. The method of claim 1 further comprising:
determining in the computer, if the club has a threshold membership;
aggregating the club with an additional club having similar geographic and demographic characteristics;
repeating the aggregation until an aggregate membership of the combined clubs exceeds a threshold; and
treating the aggregated clubs as a unit for selecting, generating, and associating.

5. The method of claim 1 wherein selecting comprises:
maintaining a database of selection criteria;
comparing the selection criteria for a particular advertiser with the geographic and demographic characteristics; and
including the particular advertiser in the subset responsive to a match in the comparing.

6. The method of claim 1 further comprising:
creating informational correspondence to club members including member specific offers from the subset of advertisers.

7. The method of claim 1 further comprising:
distributing an identification token to each club member identifying them as a member of the club.

8. The method of claim 1 further comprising:
collecting revenue from each advertiser in the subset; and
distributing a portion of the revenue to the club.

9. A system comprising:
a processor;
a database of participating clubs;
an interface for access by advertisers from a pool of advertisers, wherein the interface accepts a specification identifying demographic and geographic characteristics of a population an accessing advertiser wants to target;
a customer relations management (CRM) module executing on the processor to match the specifications with clubs having membership consistent with the demographic and geographic characteristics; and
a website management (WSM) module executing on the processor generating a unique website for each participating club, the WSM module populating the website with image based advertisements from an approved subset of advertisers, the WSM activating the website associated with a club after a threshold number of advertisers are approved.

10. The system of claim 9 wherein the CRM module generates a token for each member of a token for each member of a participating club, the token providing access to special offer from the approved advertisers on the website associated with the club.

11. The system of claim 9 wherein the interface for access by advertisers accepts a base image advertisement and contact information for a plurality of branches of the advertiser, and wherein the WSM module automatically overlays local branch contact information on the base image when populating the website associated with the club.

12. The system of claim 9 wherein the CRM module triggers a notification to a subset of advertisers responsive to availability of a new club having demographic and geographic characteristics consistent with the specification for each advertiser in the subset.

13. The system of claim 9 further comprising:
an accounting module to process payment for the advertising and forward a portion of the revenues from advertising on the particular club associate website to the particular club.

14. The system of claim 9 wherein the WSM module triggers installation of a link on a home page of the club to the website associated with the club responsive to activation of that website.
